(19) United States
(12) Patent Application Publication
(10) Pub. No.: US 2006/0031574 A1
(43) Pub. Date: Feb. 9, 2006

(54) Business model for packaging and delivering internet-mail

(75) Inventor: Kim Simelius, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/875,611

(22) Filed: Jun. 24, 2004

(51) Int. Cl. G06F 15/173

(52) U.S. Cl. 709/238

(57) ABSTRACT

This invention describes a method for packaging and delivering secure internet-mail (I-mail) content reliably within a communication system (e.g., a mobile communication system) using a business model. The invention enables a business model of courier services like DHL or UPS for e-mail applications. The basic idea of the invention is to provide a packaging application at the user's terminal, but after the content has been packaged, to leave the delivery of the package to an operator-assisted system. For example, the transfer of the package from the terminal to the network, address resolution, making sure the receiver is able to read the content, security and charging are taken care by the system operators.

### TECHNICAL FIELD

This invention generally relates to an internet e-mail and more specifically to packaging and delivering secure internet-mail using a business model.

### BACKGROUND ART

1. Field of Technology and Background

An internet and an internet based e-mail transport mechanism have become very popular, and e-mail is seen as one of the core applications in a business environment. The basic idea of the e-mail is that the user puts together a package of text and attachments, sends it to the nearest e-mail server and the e-mail servers transport it towards the receiver based on the e-mail address in the package. Using an analogy with ordinary mail, the e-mail is very much like the ordinary package having the content and the receiver's address, and the e-mail package is “dropped” to the nearest post office.

2. Problem Formulation

The e-mail is becoming increasingly congested by viral mails and spamming. It has been realized for a long time that the e-mail is not a secure system since eavesdropping or intercepting e-mails is relatively easy. In other words, the e-mail can get lost (although this is rare), it can be excessively delayed or its content can be stolen, just like in the case of the regular mail.

3. Prior Art

Private e-mail systems are somewhat protected from the adverse developments of the internet e-mail, since viral e-mails and spamming can mostly be kept out of the system. Private e-mail systems can also be more secure than the internet e-mail. The e-mail can also be encrypted using, e.g., a PGP (pretty good privacy) application. However, there is no fool proof way to make sure that the e-mail gets safely to the receiver, since the internet delivery system is becoming unreliable, and the security systems are tedious to use.

### DISCLOSURE OF THE INVENTION

The object of the present invention is to provide a methodology for secure packaging and delivering internet-mail (I-mail) content reliably within a communication system using a business model, according to the present invention.

According to a first aspect of the invention, a method for packaging and delivering electronic content within a communication system, comprising: providing a content and receiver information signal containing the electronic content and receiver identity information to a sending operator by a compatible sender; encrypting the electronic content by the sending operator; providing a package signal containing the encrypted electronic content and the receiver identity information to a network; and routing the package signal by the network using the receiver identity information to a receiving operator for delivering the content to a receiver.

According further to the first aspect of the invention, the receiver identity information may not contain an e-mail address of the receiver.

Further according to the first aspect of the invention, the routing may take place at least partly manually.

Still further according to the first aspect of the invention, the compatible sender, or the receiver, or both the compatible sender and the receiver may be user terminals of the communication system. Further, the sending operator and the receiving operator may be network elements of the communication system. Still further, the compatible sender may include capabilities of the receiver and the receiving operator may include capabilities of the sending operator.

According further to the first aspect of the invention, the routing of the package signal is performed by a network operator of the network through one or more nodes out of N nodes of the network using the receiver identity information and based on a predetermined criterion, wherein N is an integer of at least a value of one. Further, the method may further comprise: determining if the receiving operator is capable of delivering the electronic content to the receiver. Still further, if the receiving operator is not capable of delivering the electronic content to the receiver, the method may further comprise: routing the package signal to a further receiving operator for delivering the content to the receiver. Yet still further, the method may comprise: identifying the receiver by the receiving operator using the receiver identity information contained in the package signal and optionally confirming authenticity of the receiver.

According still further to the first aspect of the invention, the method may further comprise: charging the compatible sender for delivering the content to the receiver optionally based on a size of the content or using a fixed rate for each delivery by providing a charging signal to the compatible sender.

According further still to the first aspect of the invention, before providing the content and receiver information signal, the method may further comprise: preliminary encrypting the electronic content of the content and receiver information signal by the compatible sender using a public key or a one-time key provided to the compatible sender by the sending operator. Further, the method may further comprise: charging the compatible sender for the one-time keys by the sending operator, if the one-time key is used for the preliminary encrypting. Still further, before encrypting the electronic content by the sending operator, the method may further comprise: decrypting, upon receiving, the electronic content of the content and receiver information signal by a secure mode server of the sending operator using the public key or the one-time key provided to the compatible sender by the sending operator, wherein the sending operator does not have an access to the decrypted electronic content.

According yet further still to the first aspect of the invention, the encryption may be performed using an operator public key.

Yet still further according to the first aspect of the invention, the method may further comprise: identifying a mode of the delivery of the content by the receiving operator to the receiver by negotiating between the receiving operator and the receiver; and providing a delivery signal containing the electronic content to the receiver by the receiving operator using the mode of the delivery. Further, before providing the delivery signal, the method may further comprise: decrypting, upon receiving, the electronic content of the package signal optionally by a secure mode server of the receiving operator; and optionally further encrypting the electronic content using a receiver key, wherein the receiver key is provided to the receiving operator based on the identified mode of delivery, and wherein the receiving operator does not have an access to the decrypted electronic content if it was decrypted by the secure mode server and before it is further encrypted. Still further, if the sending operator uses a public PGP (pretty good privacy) key of the receiver to encrypt the electronic content and the delivery signal contains the electronic content encrypted by the sending operator, decrypting of the electronic content may be optionally performed by the receiver after receiving the delivery signal.

Still yet further according to the first aspect of the invention, the communication system may be a mobile communication system. Further, the receiver may be a regular mail box or a fax machine.

According to a second aspect of the invention, a computer program product comprising: a computer readable storage structure embodying computer program code thereon for execution by a computer processor with the computer program code characterized in that it includes instructions for performing the steps of first aspect of the invention indicated as being performed by any component or a combination of components of the communication system.

According to a third aspect of the invention, a communication system for packaging and delivering electronic content, comprising: a compatible sender, for providing a content and receiver information signal containing the content and receiver identity information; a sending operator, responsive to the content and receiver information signal for encrypting the electronic content and for providing a package signal containing the encrypted electronic content and the receiver identity information; a network, responsive to the package signal, for routing the package signal using the receiver identity information; and a receiving operator, responsive to the package signal, for delivering the electronic content to a receiver.

According further to the third aspect of the invention, the receiver identity information may not contain an e-mail address of the receiver.

Further according to the third aspect of the invention, the routing may take place at least partly manually.

Still further according to the third aspect of the invention, the compatible sender, or the receiver, or both the compatible sender and the receiver may be user terminals of the communication system. Further, the sending operator and the receiving operator may be network elements of the communication system. Still further, the compatible sender may include capabilities of the receiver and the receiving operator may include capabilities of the sending operator.

According further to the third aspect of the invention, the routing of the package signal may be performed by a network operator of the network through one or more nodes out of N nodes of the network using the receiver identity information and based on a predetermined criterion, wherein N is an integer of at least a value of one. Further, the communication system may further comprise: a further receiving operator, responsive to the package signal provided by the receiving operator if the receiving operator is not capable of delivering the electronic content to the receiver, for delivering the electronic content to the receiver. Still further, the receiver may be identified by the receiving operator using the receiver identity information contained in the package signal and optionally confirms authenticity of the receiver.

According still further to the third aspect of the invention, before providing the content and receiver information signal, the electronic content of the content and receiver information signal may be preliminary encrypted by the compatible sender using a public key or a one-time key provided to the compatible sender by the sending operator. Further, before encrypting the electronic content by the sending operator, the electronic content of the content and receiver information signal may be decrypted upon receiving by a secure mode server of the sending operator using the public key or the one-time key provided to the compatible sender by the sending operator, wherein the sending operator does not have an access to the decrypted electronic content.

According yet further still to the third aspect of the invention, the encryption may be performed using an operator public key.

According further still to the third aspect of the invention, a mode of the delivery of the content by the receiving operator to the receiver may be negotiated between the receiving operator and the receiver and a delivery signal containing the electronic content is provided to the receiver by the receiving operator using the mode of the delivery. Further, before providing the delivery signal, the electronic content of the package signal may be decrypted upon receiving, optionally by a secure mode server of the receiving operator, and optionally the electronic content may be further encrypted using a receiver key, wherein the receiver key is provided to the receiving operator based on the identified mode of delivery, and wherein the receiving operator does not have an access to the decrypted electronic content if it was decrypted by the secure mode server and before it is further encrypted.

Yet still further according to the third aspect of the invention, if the sending operator uses a public PGP (pretty good privacy) key of the receiver to encrypt the electronic content and the delivery signal contains the electronic content encrypted by the sending operator, decrypting of the electronic content may be optionally performed by the receiver after receiving the delivery signal.

Still yet further according to the third aspect of the invention, the communication system may be a mobile communication system.

According to a fourth aspect of the invention, a network for routing a package signal containing an electronic content in an encrypted format and receiver identity information, comprising: a network operator, responsive to the package signal, for providing routing instructions using the receiver identity information and based on a predetermined criterion; and N nodes, responsive to the routing instructions, for routing the package signal with the electronic content in the encrypted format through the one or more nodes out of the N nodes based on the routing instructions to a receiving operator which delivers the electronic content to a receiver, wherein the receiver identity information does not have to contain an e-mail address of the receiver.

According to a fifth aspect of the invention, a compatible sender, comprising: a packaging block, for packaging an electronic content and receiver identity information; and a sending block, for providing a content and receiver information signal containing the electronic content and the receiver identity information to a sending operator for encrypting and further delivering the electronic content to a receiver, wherein the receiver identity information does not have to contain an e-mail address of the receiver.

According further to the fifth aspect of the invention, the packaging block and the sending block may be combined in one block.

Further according to the fifth aspect of the invention, the compatible sender may be a user terminal of a communication system.

According to a sixth aspect of the invention, a sending operator, comprising: an encrypting block for encrypting an electronic content contained in a content and receiver information signal provided by a compatible sender; and a forwarding block, for providing a package signal containing the encrypted electronic content and receiver identity information to a network for routing and further delivering the electronic content to a receiver, wherein the receiver identity information is included in the content and receiver information signal and does not have to contain an e-mail address of the receiver.

According further to the sixth aspect of the invention, the encrypting block and the forwarding block may be combined in one block.

Further according to sixth aspect of the invention, the sending may be a network element of the communication network.

The present invention improves the usability, reliability and security of the e-mail for business purposes. It also creates a business opportunity for a company running an I-mail service. The users of the system have to pay for the delivery, but they get reliability in exchange. Therefore, the I-mail system is ideal for business environments.

### BRIEF DESCRIPTION OF THE DRAWINGS

For a better understanding of the nature and objects of the present invention, reference is made to the following detailed description taken in conjunction with the following drawings, in which:

FIG. 1 shows an example of a block diagram of a communication system for packaging and delivering internet-mail (I-mail) content, according to the present invention;

FIGS. 2a and 2b show examples of implementing an I-mail compatible sender and a sending I-mail operator, respectively, according to the present invention; and

FIG. 3 shows an example of a flow chart demonstrating a performance of a communication system for packaging and delivering internet-mail (I-mail) content, according to the present invention.

### BEST MODE FOR CARRYING OUT THE INVENTION

The present invention provides a new methodology for secure packaging and delivering internet-mail (I-mail) content reliably within a communication system (e.g., a mobile communication system) using a business model, according to the present invention.

The invention enables a business model of courier services like DHL or UPS for e-mail applications. The basic idea of the invention is to provide a packaging application at the user's terminal, but after the content has been packaged, to leave the delivery of the package to an operator-assisted system. For example, the transfer of the package from the terminal to the network, address resolution, making sure the receiver is able to read the content, security and charging are taken care of by the system operators.

The present invention describes a communication system having a terminal device (an I-mail compatible sender) supporting an I-mail application, a network element (a sending I-mail operator) for encrypting and forwarding I-mail packages, an I-mail network for routing the I-mail packages, and another network element (a receiving I-mail operator) for delivering said package to a receiver, wherein charging is based on the delivery of the package.

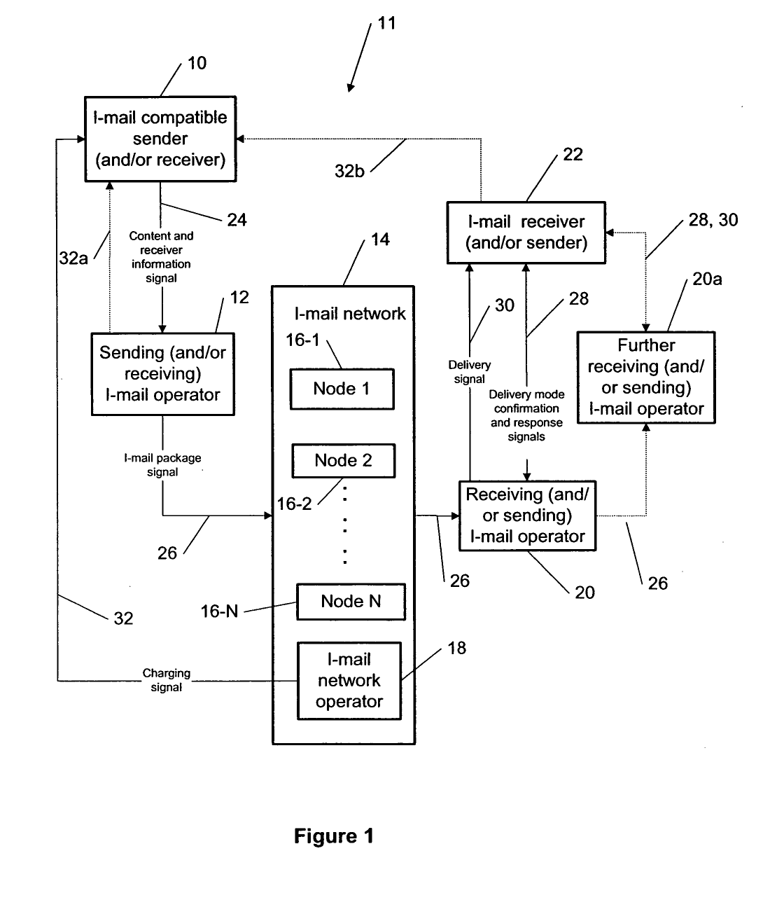

FIG. 1 shows one example among others of a block diagram of a communication system 11 (e.g., a mobile communication system) for packaging and delivering internet-mail (I-mail) content, according to the present invention.

To arrange for secure delivery, according to the present invention, the user of the system can download an I-mail application to an I-mail compatible sender (also referred to as a compatible sender or a user terminal) 10. When the user wants to send I-mail content (also referred to as electronic content), the I-mail application enables the user to put together a package in much the same way as a regular e-mail editor. However, there is no need to arrange for the encryption of the I-mail content with the receiver public key, according to the present invention, and the I-mail compatible sender 10 provides a content and receiver information signal 24 containing said I-mail content and receiver identity information to a sending I-mail operator (also referred to as a sending operator) 12. Thus, the user (or equivalently the I-mail compatible sender 10) is freed from arranging the encryption. Moreover, the user does not need to find the right e-mail address, it suffices to provide enough information so that the receiver can be identified. Besides sending I-mail content, the I-mail compatible sender 10 can be also used to assist in reception of I-mail packages if the user so wishes.

In the regular e-mail, the addressing is a problem in a sense that it is either difficult to find the recipient's e-mail address, or at least it is difficult to know which e-mail address is the most appropriate. According to the present invention, the problem is solved in such a way that the I-mail compatible sender 10 provides as much addressing information as possible (name, street address, employer, phone numbers, fax, e-mail addresses etc.) in said signal 24, however, as pointed out above, the receiver identity information does not have to contain the receiver's e-mail address (i.e., it is not mandatory). This receiver identity information is used further in the communication system 11 as described below to locate and contact the appropriate receiver, whereby the receiver is then able to choose the mode of delivery that is most suitable for the recipient.

To secure the I-mail content, the sending I-mail operator 12 encrypts said I-mail content, using, e.g., an I-mail operator public key (also referred to as an operator public key), and provides an I-mail package signal (also referred to as a package signal) 26 containing said encrypted I-mail content and said receiver identity information to an I-mail network 14, as shown in FIG. 1. The encryption can take place in the user terminal 10 in a manner transparent to the user, wherein the sending I-mail operator 12 provides a public key to the I-mail application, which then arranges the encryption of the package possibly using enhanced capabilities of the user terminal 10, for example, a secure encryption mode of the processor. This way, the user is freed from considering the encryption.

The routing of the I-mail package signal 26 of the present invention is considered next. In the regular e-mail, routing is automatic. In the I-mail, the initial routing is at least partly manual, whereby the local I-mail operator 12 can arrange providing the package (signal 26) to the I-mail network (also referred to as a network) 14. The I-mail network 14 at least party automatically routes said I-mail package signal 26 using said receiver identity information to a receiving I-mail operator (also referred to as a receiving operator) 20 for delivering said I-mail content to an I-mail receiver (also referred to as a receiver) 22, wherein said receiver identity information does not have to contain an e-mail address of the I-mail receiver 22 as pointed out earlier. In a preferred embodiment of the present invention the receiving I-mail operator 20 is presumed to be the closest or otherwise most convenient I-mail operator to the I-mail receiver 22 (e.g., another user terminal). The routing of the I-mail package signal 26 can be performed by an I-mail network operator 18 of the I-mail network 14 through one or more nodes out of N nodes 16-1, 16-2, . . . , 16-N of said I-mail network 14 using said receiver identity information and based on a predetermined criterion, wherein N is an integer of at least a value of one.

It is noted that, according to the present invention, the I-mail compatible sender 10 can include capabilities of the I-mail receiver 22 and similarly the receiving I-mail operator 20 can include capabilities of the sending I-mail operator 12.

The delivery or a mode of delivery of the package (the I-mail content) can vary in a number of ways including but not be limited to the regular e-mail, some kind of pushing (ftp, http, wap), secure posting on the internet and delivery of the link, fax or even delivery in a paper format or on removable media like CD-ROM, DVD-ROM, FLASH memory, floppy disk, etc. Therefore the I-mail receiver 22 can be, e.g., a secure regular mail box or a fax machine, not related to the internet at all, and the delivery can make use of a regular secure courier service.

Further processing proceeds as follows. First, said I-mail receiver 22 is identified by the receiving I-mail operator 20 using said receiver identity information contained in said I-mail package signal 26 and optionally confirms authenticity of said I-mail receiver 22. Then, the receiving I-mail operator 20 determines if the receiving I-mail operator 20 is capable of delivering said I-mail content to said I-mail receiver 22. If it is not the case, said I-mail package signal 26 is further routed to a further receiving I-mail operator 20a for delivering said I-mail content to said I-mail receiver 22.

The receiving I-mail operator 20 (or the further receiving I-mail operator 20a) negotiates with said I-mail receiver 22 the mode of delivery of said I-mail content to said I-mail receiver 22 using a delivery mode confirmation and response signal 28, and a delivery signal 30 containing said I-mail content is provided to the I-mail receiver 22 by the receiving I-mail operator 20 (or by the further receiving I-mail operator 20a) using said negotiated mode of delivery. This negotiation can take place automatically, for example in the case the receiver 22 is a user of the I-mail system, or manually by telephone or by fax if the receiver 22 is not a user of the I-mail system. A decryption of the encrypted I-mail content can be performed by the receiving I-mail operator 20 before providing said delivery signal 30, or, if the sending I-mail operator 12 uses a public PGP (pretty good privacy) key of the I-mail receiver 22 to encrypt said I-mail content, said decryption of the encrypted I-mail content can be performed by the I-mail receiver 22 after receiving said delivery signal 30.

It is noted, that according to the present invention, the I-mail content delivery does not necessarily need to happen to the address provided in the receiver identity information if the authenticity of the receiver can be confirmed as mentioned above.

According to the present invention, different charging models are possible. Charging can be done by the I-mail network operator 18 by providing a charging signal 32 to the I-mail compatible sender 10 based on the size of the I-mail content, unit-based (fixed for each delivery), or any other reasonable and cost-based scheme. Charging can also be done by the sending I-mail operator 12 (see signal 32a) directly, which is the preferable option in cases where the I-mail network operator 18 does not have charging in place (e.g., for the internet). The delivery can be also charged from the I-mail receiver 22 (signal 32b) as shown in FIG. 1. Also, it is possible to offer a service where there is little or no charge if the package is not delivered, and a higher charge if expedited delivery, high security or other extended services are required.

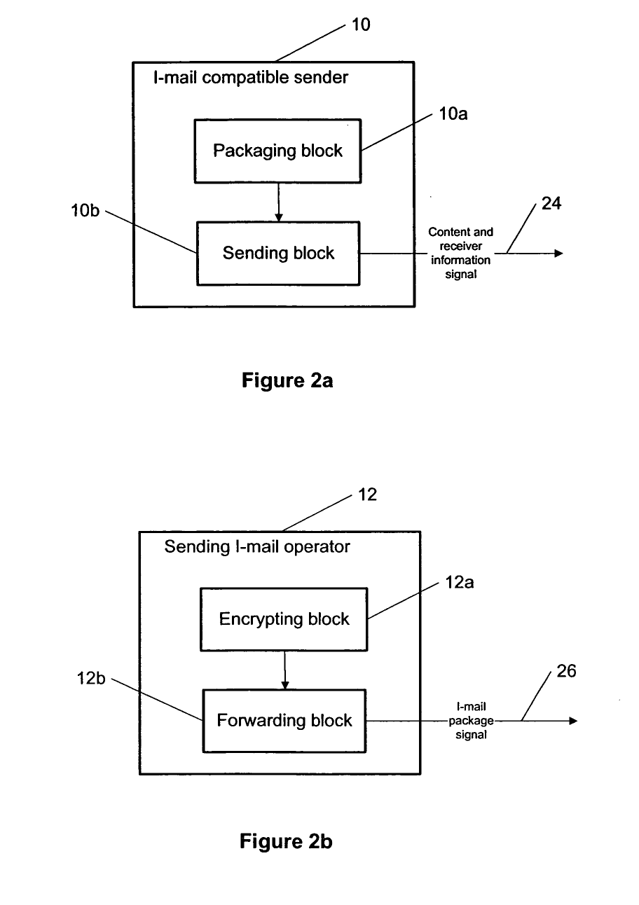

FIGS. 2a and 2b show just two examples among others of implementing of the I-mail compatible sender 10 and the ending I-mail operator 12, respectively, according to the present invention.

The I-mail compatible sender (or the user terminal) 10 in FIG. 2a comprises a packaging block 10a used for packaging an I-mail content and receiver identity information described above and a sending block 10b used for providing the content and receiver information signal 24 containing said I-mail content and said receiver identity information to the sending I-mail operator 12 for further processing as described above. The packaging block 10a and the sending block 10b can be combined in one block, according to the present invention.

The I-mail compatible sender 10 may be capable of encrypting the I-mail package (the signal 24) for delivering to the sending I-mail operator 12. In such a case, the encryption may take place using an encryption key, e.g. a public key of a private/public asymmetric key system, or the key of a symmetric key system, provided by the sending I-mail operator 12 to the I-mail compatible sender 10. This delivery of the key may take place on request when the I-mail is being delivered to the sending I-mail operator 12, or the key may have been delivered to the I-mail compatible sender earlier. For example, it is possible to have one-time key delivered to the I-mail compatible sender 12, whereby these key may be accompanied with a charge.

Before sending the message further in the I-mail network 14, the sending I-mail operator 12 needs to decrypt the message (and further encrypt as described above) using a suitable decryption key, for example the private key corresponding to the public key used to encrypt the message. In the case of the one-time key, the sending I-mail operator needs to determine the key to be used for decrypting. This determination can be performed based on information contained in the sending I-mail operator 12, or in the I-mail network 14. In the former case, the one-time key is specific to the I-mail operator 12, but in the latter case, the one-time key can be used with any sending I-mail operator of the system.

It is noted that whenever we go from one encryption to another (e.g., from the sender-operator to the operator-network), the trans-encryption needs to take place securely, e.g. so that the sending operator 12 cannot access the unencrypted content. This can be arranged in the sending operator 12 server so that the key is only accessible in a secure mode of the server, and in this mode the encryption can be changed, but there is no access allowed to the server secure mode by the operator, and the unencrypted content is never stored in the unencrypted format. The unencrypted content is only available in a RAM memory of the server in a secure mode, and when the server exits the secure mode, said unencrypted content is erased.

The sending I-mail operator 12 comprises an encrypting block 12a used for encrypting an I-mail content contained in the content and receiver information signal 24 provided by the I-mail compatible sender (or the user terminal) 10 and a forwarding block 12b used for providing the I-mail package signal 26 containing said encrypted I-mail content and receiver identity information to the I-mail network 14 for routing and further delivering said I-mail content to the I-mail receiver 22 as described above. The encrypting block 12a and the forwarding block 12b can be combined in one block, according to the present invention. As described earlier, it may be necessary first to decrypt the package (signal 24) from the I-mail sender 10 to 10 provide an unencrypted electronic content, and subsequently encrypt the electronic content for delivering the I-mail package signal 26 to the I-mail network 14.

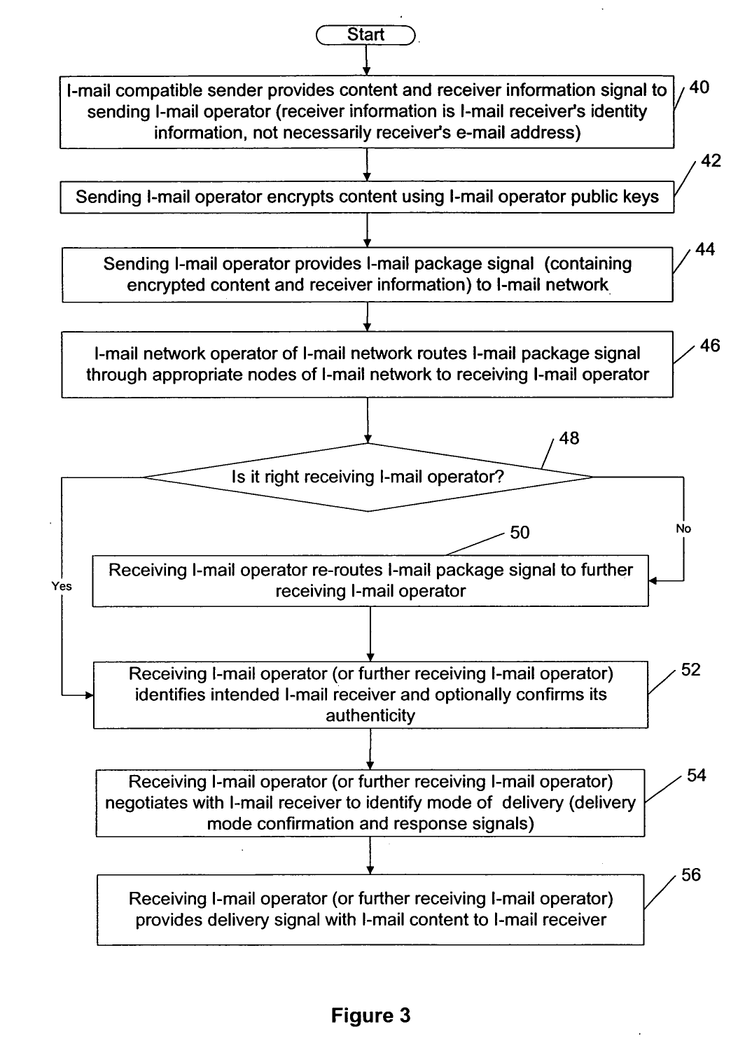

FIG. 3 shows an example of a flow chart demonstrating a performance of a communication system 11 for packaging and delivering internet-mail (I-mail) content, according to the present invention.

The flow chart of FIG. 3 represents only one possible scenario among many others. In a method according to the present invention, in a first step 40, the I-mail compatible sender 10 provides the content and receiver information signal 24 containing the I-mail content and the receiver identity information to the sending I-mail operator 12 (the receiver identity information does not necessarily contain the receiver's e-mail address). In a next step 42, the sending I-mail operator 12 encrypts the I-mail content using the I-mail operator public key. In a next step 44, the sending I-mail operator 12 provides the I-mail package signal 26 (containing the encrypted I-mail content and the receiver information) to the I-mail network 14. In a next step 46, the I-mail network operator 18 of the I-mail network 14 routes the I-mail package signal 26 through the appropriate nodes of the I-mail network 14 to the receiving I-mail operator 20. In a next step 48, it is determined whether the receiving I-mail operator 20 is capable of delivering the I-mail content to the I-mail receiver 22. If that is the case, the process goes to step 52. If, however, it is determined that the receiving I-mail operator 20 is not capable of delivering the I-mail content to the I-mail receiver 22, in a step 50, the receiving I-mail operator 20 re-routes the I-mail package signal 26 to the further receiving I-mail operator 20a.

In a next step 52, the receiving I-mail operator 20 (or the further receiving I-mail operator 20a) identifies the intended I-mail receiver 22 and optionally confirms its authenticity. In a next step 54, the receiving I-mail operator 20 (or the further receiving I-mail operator 20a) negotiates (using the delivery mode confirmation and response signals 28) with the I-mail receiver 22 to identify the mode of delivery. And finally, in a next step 56, the receiving I-mail operator 20 (or the further receiving I-mail operator 20a) provides the delivery signal 30 with the I-mail content to the I-mail receiver 22.

A decryption of the encrypted I-mail content can be performed by the receiving I-mail operator 20 (or the further receiving I-mail operator 20a) before providing said delivery signal 30 or, if the sending I-mail operator 12 uses a key of the I-mail receiver 22, e.g. a public PGP (pretty good privacy) key of the I-mail receiver 22, to encrypt said I-mail content, said decryption of the encrypted I-mail content can be optionally performed by the I-mail receiver 22 after receiving said delivery signal 30. In the latter case, it may be necessary to decrypt the package (signal 26) in the I-mail network 14 or in the receiving I-mail operator 20 and re-encrypt it with a key that can be used for transmission to the I-mail receiver to form a message that the I-mail receiver 22 can decrypt.

What is claimed is:

1. A method for packaging and delivering electronic content within a communication system, comprising:
providing a content and receiver information signal containing said electronic content and receiver identity information to a sending operator by a compatible sender;
encrypting said electronic content by the sending operator;
providing a package signal containing said encrypted electronic content and said receiver identity information to a network; and
routing said package signal by the network using said receiver identity information to a receiving operator for delivering said content to a receiver.

2. The method of claim 1, wherein said receiver identity information does not contain an e-mail address of the receiver.

3. The method of claim 1, wherein said routing takes place at least partly manually.

4. The method of claim 1, wherein said compatible sender, or said receiver, or both said compatible sender and said receiver are user terminals of said communication system.

5. The method of claim 1, wherein said sending operator and said receiving operator are network elements of said communication system.

6. The method of claim 1, wherein said compatible sender includes capabilities of the receiver and said receiving operator includes capabilities of the sending operator.

7. The method of claim 1, wherein the routing of said package signal is performed by a network operator of the network through one or more nodes out of N nodes of said network using said receiver identity information and based on a predetermined criterion, wherein N is an integer of at least a value of one.

8. The method of claim 7, further comprising:
determining if the receiving operator is capable of delivering said electronic content to said receiver.

9. The method of claim 8, wherein if the receiving operator is not capable of delivering said electronic content to said receiver, the method further comprises:
routing said package signal to a further receiving operator for delivering said content to said receiver.

10. The method of claim 7, further comprising:
identifying said receiver by the receiving operator using said receiver identity information contained in said package signal and optionally confirming authenticity of said receiver.

11. The method of claim 1, further comprising:
charging the compatible sender for delivering the content to the receiver optionally based on a size of the content or using a fixed rate for each delivery by providing a charging signal to the compatible sender.

12. The method of claim 1, wherein before providing the content and receiver information signal, the method further comprises:
preliminary encrypting the electronic content of the content and receiver information signal by the compatible sender using a public key or a one-time key provided to said compatible sender by the sending operator.

13. The method of claim 12, further comprising:
charging the compatible sender for the one-time keys by the sending operator, if said one-time key is used for said preliminary encrypting.

14. The method of claim 12, wherein before encrypting said electronic content by the sending operator, the method further comprises:
decrypting, upon receiving, the electronic content of the content and receiver information signal by a secure mode server of the sending operator using said public key or said one-time key provided to said compatible sender by the sending operator, wherein the sending operator does not have an access to the decrypted electronic content.

15. The method of claim 1, wherein said encryption is performed using an operator public key.

16. The method of claim 1, further comprising:
identifying a mode of said delivery of said content by the receiving operator to said receiver by negotiating between the receiving operator and said receiver; and
providing a delivery signal containing said electronic content to the receiver by the receiving operator using said mode of said delivery.

17. The method of claim 16, wherein before providing said delivery signal, the method further comprises:
decrypting, upon receiving, the electronic content of the package signal optionally by a secure mode server of the receiving operator; and
optionally further encrypting said electronic content using a receiver key, wherein said receiver key is provided to the receiving operator based on said identified mode of delivery, and wherein the receiving operator does not have an access to the decrypted electronic content if it was decrypted by said secure mode server and before it is further encrypted.

18. The method of claim 16, wherein, if the sending operator uses a public PGP (pretty good privacy) key of the receiver to encrypt said electronic content and the delivery signal contains said electronic content encrypted by the sending operator, decrypting of the electronic content is optionally performed by the receiver after receiving said delivery signal.

19. The method of claim 1, wherein said communication system is a mobile communication system.

20. The method of claim 1, wherein said receiver is a regular mail box or a fax machine.

21. A computer program product comprising: a computer readable storage structure embodying computer program code thereon for execution by a computer processor with said computer program code characterized in that it includes instructions for performing the steps of the method of claim 1 indicated as being performed by any component or a combination of components of said communication system.

22. A communication system for packaging and delivering electronic content, comprising:
a compatible sender, for providing a content and receiver information signal containing said content and receiver identity information;
a sending operator, responsive to said content and receiver information signal for encrypting said electronic content and for providing a package signal containing said encrypted electronic content and said receiver identity information;
a network, responsive to said package signal, for routing said package signal using said receiver identity information; and
a receiving operator, responsive to said package signal, for delivering said electronic content to a receiver.

23. The communication system of claim 22, wherein said receiver identity information does not contain an e-mail address of the receiver.

24. The communication system of claim 22, wherein said routing takes place at least partly manually.

25. The communication system of claim 22, wherein said compatible sender, or said receiver, or both said compatible sender and said receiver are user terminals of said communication system.

26. The communication system of claim 22, wherein said sending operator and said receiving operator are network elements of said communication system.

27. The communication system of claim 22, wherein said compatible sender includes capabilities of the receiver and said receiving operator includes capabilities of the sending operator.

28. The communication system of claim 22, wherein the routing of said package signal is performed by a network operator of the network through one or more nodes out of N nodes of said network using said receiver identity information and based on a predetermined criterion, wherein N is an integer of at least a value of one.

29. The communication system of claim 28, further comprising:
a further receiving operator, responsive to said package signal provided by the receiving operator if the receiving operator is not capable of delivering said electronic content to said receiver, for delivering said electronic content to said receiver.

30. The communication system of claim 28, wherein said receiver is identified by the receiving operator using said receiver identity information contained in said package signal and optionally confirms authenticity of said receiver.

31. The communication system of claim 22, wherein before providing the content and receiver information signal, the electronic content of the content and receiver information signal is preliminary encrypted by the compatible sender using a public key or a one-time key provided to said compatible sender by the sending operator.

32. The communication system of claim 31, wherein before encrypting said electronic content by the sending operator, the electronic content of the content and receiver information signal is decrypted upon receiving by a secure mode server of the sending operator using said public key or said one-time key provided to said compatible sender by the sending operator, wherein the sending operator does not have an access to the decrypted electronic content.

33. The communication system of claim 22, wherein said encryption is performed using an operator public key.

34. The communication system of claim 22, wherein a mode of said delivery of said content by the receiving operator to said receiver is negotiated between the receiving operator and said receiver and a delivery signal containing said electronic content is provided to the receiver by the receiving operator using said mode of said delivery.

35. The communication system of claim 34, wherein before providing said delivery signal, the electronic content of the package signal is decrypted upon receiving, optionally by a secure mode server of the receiving operator, and optionally said electronic content is further encrypted using a receiver key, wherein said receiver key is provided to the receiving operator based on said identified mode of delivery, and wherein the receiving operator does not have an access to the decrypted electronic content if it was decrypted by said secure mode server and before it is further encrypted.

36. The communication system of claim 22, wherein, if the sending operator uses a public PGP (pretty good privacy) key of the receiver to encrypt said electronic content and the delivery signal contains said electronic content encrypted by the sending operator, decrypting of the electronic content is optionally performed by the receiver after receiving said delivery signal.

37. The communication system of claim 22, wherein said communication system is a mobile communication system.

38. A network for routing a package signal containing an electronic content in an encrypted format and receiver identity information, comprising:
a network operator, responsive to said package signal, for providing routing instructions using said receiver identity information and based on a predetermined criterion; and
N nodes, responsive to said routing instructions, for routing said package signal with said electronic content in the encrypted format through said one or more nodes out of said N nodes based on said routing instructions to a receiving operator which delivers said electronic content to a receiver, wherein said receiver identity information does not have to contain an e-mail address of said receiver.

39. A compatible sender, comprising:
a packaging block, for packaging an electronic content and receiver identity information; and
a sending block, for providing a content and receiver information signal containing said electronic content and said receiver identity information to a sending operator for encrypting and further delivering said electronic content to a receiver, wherein said receiver identity information does not have to contain an e-mail address of said receiver.

40. The compatible sender of claim 39, wherein said packaging block and said sending block are combined in one block.

41. The compatible sender of claim 39, wherein said compatible sender is a user terminal of a communication system.

42. A sending operator, comprising:
an encrypting block for encrypting an electronic content contained in a content and receiver information signal provided by a compatible sender; and
a forwarding block, for providing a package signal containing said encrypted electronic content and receiver identity information to a network for routing and further delivering said electronic content to a receiver, wherein said receiver identity information is included in said content and receiver information signal and does not have to contain an e-mail address of said receiver.

43. The sending operator, of claim 42, wherein said encrypting block and said forwarding block are combined in one block.

44. The sending operator of claim 42, wherein said sending is a network element of said communication network.
